(19) United States
(12) Patent Application Publication
(10) Pub. No.: US 2017/0148345 A1
(43) Pub. Date: May 25, 2017

(54) SYSTEM AND METHOD FOR TEACHING AND LEARNING TECHNIQUE FOR ATHLETIC MOVEMENTS

(71) Applicant: MERCEDES L. DICKERSON, HAYWARD, CA (US)

(72) Inventor: MERCEDES L. DICKERSON, HAYWARD, CA (US)

(21) Appl. No.: 15/357,790

(22) Filed: Nov. 21, 2016

Related U.S. Application Data
(60) Provisional application No. 62/258,412, filed on Nov. 20, 2015.

(51) Int. Cl. G09B 19/00; A63B 69/00; A63F 9/10; A63B 21/072

(52) U.S. Cl. CPC G09B 19/0038; A63B 21/0724; A63B 69/0028; A63B 69/00; A63F 9/10

(57) ABSTRACT

A teaching implement for teaching and learning technique for an athletic movement includes a set of puzzle tiles that are connectable to form a completed picture. The completed picture depicts a first and a second position of the athletic movement. In addition, a method of learning an athletic movement includes assembling puzzle tiles of a jigsaw puzzle to form the completed picture.

### CROSS-REFERENCE TO RELATED APPLICATIONS

This application is related to, and claims the benefit of, U.S. Provisional Application No. 62/258,412 (filed Nov. 20, 2015), which is incorporated herein by reference in its entirety.

### BRIEF SUMMARY

In brief, and at a high level, this disclosure describes, among other things, a teaching implement for teaching and learning technique for an athletic movement, such as weightlifting, running, gymnastics, and the like. In addition, this disclosure describes a method of learning an athletic movement by assembling puzzle tiles of a jigsaw puzzle to form a completed picture, the completed picture depicting a first and a second position of the athletic movement.

This high-level overview is provided to introduce a selection of concepts that are further described below in the detailed-description section. This summary is not intended to identify key features or essential features of the claimed subject matter, nor is it intended to be used as an aid in isolation to determine the scope of the claimed subject matter.

### BRIEF DESCRIPTION OF THE DRAWINGS

The present invention is described in detail herein with reference to the attached figures, which are incorporated herein by reference, wherein:

FIG. 1 depicts a jigsaw-puzzle teaching implement in accordance with an aspect hereof; and

FIG. 2 depicts an alternative embodiment of a jigsaw-puzzle teaching implement in accordance with an aspect hereof.

### DETAILED DESCRIPTION

The subject matter of aspects of the present invention is described with specificity herein to meet statutory requirements. But the description itself is not intended to necessarily limit the scope of claims. Rather, the claimed subject matter might be embodied or carried out in other ways to include different elements or combinations of elements similar to the ones described in this document, in conjunction with other present or future technologies.

An aspect of this disclosure includes an implement for teaching and learning technique for an athletic movement, such as weightlifting, running, gymnastics, and the like. Generally, the teaching implement includes a jigsaw puzzle having a plurality of puzzle tiles that are connectable with one another to form a completed puzzle. Each puzzle tile includes a portion of a larger picture, the larger picture depicting an individual performing the athletic movement. The athletic movement includes an execution of a series of sequential movements, and the picture depicts at least a first position of the athletic movement and a second position of the athletic movement that occurs sequentially after the first position. The teaching implement visually distills the athletic movement into sequential steps or positions and also separates each position into a subset of puzzle tiles. As such, the teaching implement is useful to reinforce both an order in which body positions occur when executing a movement, as well as differences between body positions at each stage. In addition, the tiling of the various movements draws a user's focus to a specific detail of the movement when the puzzle tiles are being assembled with one another.

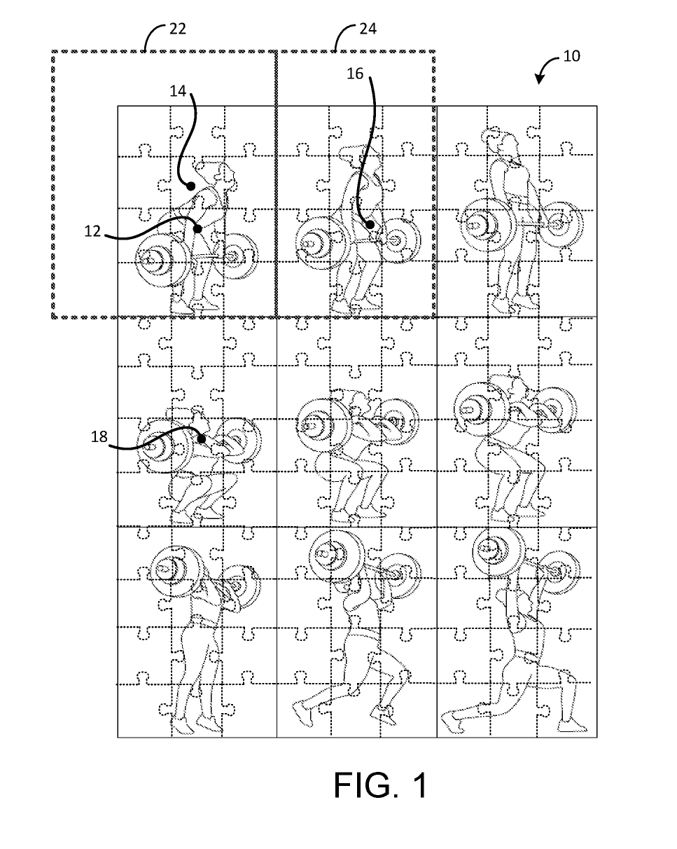

Referring now to FIG. 1, a teaching implement 10 is depicted for teaching and learning technique for an athletic movement. The teaching implement may be used to teach a variety of different movements in which a suggested form and technique are at least partially determined by the sequential execution of certain body positions. For instance, in many athletic movements a suggested technique is at least partially dependent on sequential alignment of certain joints, bones, muscles, anatomical systems (e.g., upper leg, lower leg, upper arm, shoulder, lower arm, neck, hip, etc.), and the like, and the teaching implement described in this disclosure may be utilized to facilitate understanding and comprehension of these athletic movements. Exemplary athletic movements include weightlifting, running, and gymnastics movements, and FIG. 1 more specifically illustrates a teaching implement for learning certain movements associated with the clean-and-jerk weightlifting movement.

FIG. 1 includes a jigsaw puzzle having a plurality of puzzle tiles (e.g., 12, 14, 16, and 18) that are connectable with one another to form a completed puzzle. The puzzle tiles each includes interlocking edges that are depicted in broken lines. Each puzzle tile of the plurality of puzzle tiles includes a respective portion of a larger picture, which may include photographs, lines drawings, and the like. For example, tile 12 includes a portion of a first picture of an individual executing a first position of a weightlifting movement (i.e., “first” relative to the other pictures depicted in the completed puzzle). As depicted by the teaching implement 10, the respective portions of the picture form the picture when the puzzle tiles are connected to form the completed puzzle. As previously indicated, the picture depicts an individual performing an athletic movement (e.g., clean movement in weightlifting, gymnastics movement, or running) that includes an execution of a series of sequential movements. For instance, the clean weightlifting movement includes a series of sequential body positions that move the bar from the ground to a rack position in which the barbell is supported near the shoulders of the lifter. As can be seen in FIG. 1, the picture depicts a first position of an athletic movement (i.e., in the box 22) and a second position of the athletic movement (i.e., in the box 24), the second position occurring sequentially after the first position. In FIG. 1, nine positions are depicted by the completed puzzle, although for explanatory purposes not all nine positions are expressly described herein.

In FIG. 1, the first position depicted in the box 22 includes a first hip position, a first back angle, and a first shoulder position (among other anatomical positions), and the second position depicted in the box 24 includes a second hip position, a second back angle, and a second shoulder position. When comparing the first box 22 to the second box 24 it can be seen that at least one of the second hip position, the second back angle, and the second shoulder position is different from the first hip position, the first back angle, and the first shoulder position. As such, by assembling the puzzle tiles together, the teaching implement helps to highlight subtle body-position changes that may occur from one position to the next, since the user may apply particular focus to the picture details of each puzzle tile when working to align the puzzle tiles with one another.

Although FIG. 1 depicts a clean-and-jerk weightlifting movement, the teaching implement 10 might depict various athletic movements in which respective anatomical orientations in each of the sequential positions differs. For example, the teaching implement might also depict a snatch athletic movement in which the first position includes a first hip position, a first back angle, and a first shoulder position, and the second position includes a second hip position, a second back angle, and a second shoulder position. Again, the teaching implement would illustratively depict at least one of the second hip position, the second back angle, and the second shoulder position being different from the first hip position, the first back angle, and the first shoulder position. The teaching implement might also depict running or other athletic movements in which anatomical orientations can be compared between positions, such as by looking at foot position, ankle position, knee position, hip position, shoulder position, neck position, and head position.

The completed puzzle in FIG. 1 illustratively depicts nine different positions, and other aspects of the present invention may include more than nine different depictions. Additional aspects of the present disclosure may as few as two different depictions, so long as the two different depictions include at least some different positions.

In a further embodiment, the completed puzzle may depict a first sequence of pictures depicting a first execution of different positions of an athletic movement and a second sequence of pictures depicting a second execution of the different positions of the same athletic movement. For example, the completed puzzle may depict the second sequence directly below the first sequence, such that the execution in the first sequence can be sequentially compared within the first sequence and can also be compared to the execution depicted in the second sequence. The first and second sequence may be sequential depictions of the same person, which would highlight differences by the same person between the two different executions. Alternatively, the first and second sequence may be sequential depictions of different individuals, which may highlight difference between different people (e.g., different styles) executing the same movement. Again, the assembly of the implement by interconnecting each of the pieces helps to draw specific focus to these differences to enhance learning. In an aspect in which a completed puzzle depicts two different executions of the same movement, the pictures of each sequence may be temporally spaced apart in substantially equal time increments in order to compare the relative positions of an athlete (or two different athletes) at about the same time within the respective execution.

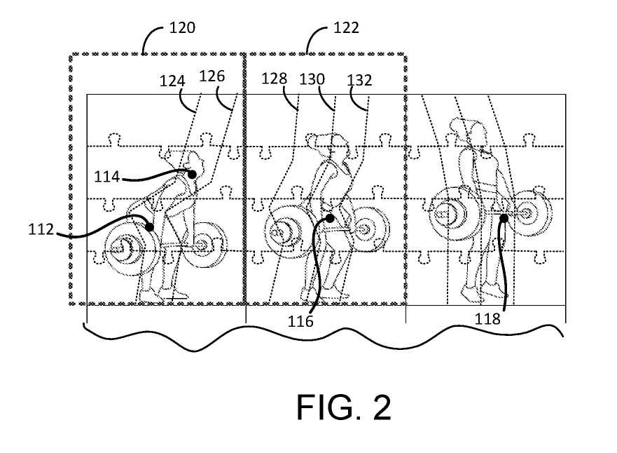

Referring now to FIG. 2, another aspect of the disclosure is depicted showing another plurality of puzzle tiles (e.g., 112, 114, 116, and 118). The plurality of puzzle tiles includes a first set of puzzle tiles that are connectable to depict the first position of the athletic movement. For example, the tiles that are included in box 120 make up a first set of puzzle tiles that are connectable to depict a first position (relative to the other depicted positions) of a clean weightlifting movement. The plurality of puzzle tiles includes a second set of puzzle tiles that are connectable to depict the second position of the athletic movement. For example, the puzzle tiles that are included in box 122 make up a second set of puzzle tiles that are connectable to depict a second position of the clean weightlifting movement. In FIG. 2, the first set of puzzle tiles includes a first interlocking-edge configuration that is repeated in each puzzle tile included in the first set of puzzle tiles. For example, reference numerals 124 and 126 identify interlocking edges that extend from the top of the first set of tiles to the bottom of the first set of tiles and that include a same edge path extending from the top to the bottom. Furthermore, the second set of puzzle tiles (i.e., in box 122) includes a second interlocking-edge configuration that is repeated in each puzzle tile included in the second set of puzzle tiles. For example, reference numerals 128, 130, and 132 identify interlocking edges that extend from the top of the second set of tiles to the bottom of the first set of tiles and that include a same edge path extending from the top to the bottom. In FIG. 2, the first interlocking-edge configuration is different from the second interlocking-edge configuration.

In a further aspect of this disclosure, the first interlocking-edge configuration (represented by lines 124 and 126) includes a first edge path that is generally aligned with a first human-joint alignment in the first position of the athletic movement. For instance, the edge path of edges 124 and 126 is generally aligned with the ankles, knees, hips, and shoulders of the individual depicted in the picture rendered by the first set of puzzle tiles. In addition, the second interlocking-edge configuration (represented by lines 128, 130, and 13) includes a second edge path that is generally aligned with a second human-joint alignment in the second position of the athletic movement. The edge path of edges 128, 130, and 132 is generally aligned with the ankles, knees, hips, and shoulders of the individual depicted in the picture rendered by the second set of puzzle tiles. By aligning edge paths with anatomical positions, the set of puzzled tiles having a consistent edge path reinforce the angles and orientations achieved in a respective position. In addition, by including different respective edge paths between different sets of puzzle tiles, the differences between one position and another position in the same sequence are highlighted.

The implement (e.g., depicted in FIG. 1 or 2) may be a physical puzzle in which each of the puzzle tiles can be physically handled and manipulated, for example, the picture may be printed (or otherwise rendered) onto a sheet of material (e.g., cardboard, paper, wood, laminate, polymer, etc.) that is then cut using a saw, die, or other cutting device. In addition, the implement 10 may be a virtual or digital puzzle in which the puzzle tiles can be assembled on a computing device. For example, the puzzle textiles may be manipulated within a computing application using various types of input devices, such as a touch sensitive screen or surface, a mouse, a joystick, and the like. In a digital version, the number of puzzle tiles may be customizable by the user. For example, FIG. 1 includes 108 puzzle tiles, and in a digital version, the number of puzzle tiles may be increased or decreased in real time. In addition, the tile-edge configuration can be adjusted in real time, such as by switching from the style depicted in FIG. 1 to the style depicted in FIG. 2.

If the implement is digital, then the system may include additional computing components that allow for the puzzle tiles to be rendered and manipulated. For example, the computing application may run on a computing device having a processor and computer memory for storing computer-executable instructions that, when executed by the processor, allow for the puzzle tiles to be displayed and moved. The computing device may include a monitor or screen that displays a graphical user interface, which is usable to render information and received user-provided input (e.g., touch-screen input, cursor input, mouse input, text input, and the like). The graphical user interface may include various manners of receiving input, such as a search query box that allows a user to search for athletes, movements, technique styles, and the like. In addition, the graphical user interface may include pre-configured tile-number buttons that are pre-coded to divide the puzzle into a set number of pieces when the button is selected. For example, a GUI button may be pre-configured as “35,” such that when the GUI button is selected, the puzzle is divided into 35 puzzle tiles. Any number of pre-configured buttons are possible, such as (but not limited to) 4, 6, 9, 12, 20, 35, 48, 108, 140, etc.

Another aspect of the present disclosure includes method of learning or teaching technique of an athletic movement. A first position of the athletic movement is observed by assembling a first portion of a jigsaw puzzle, the first portion of the jigsaw puzzle including a first plurality of puzzle tiles (e.g., 22 or 120). As previously described, puzzle tiles included in the first plurality of puzzle tiles are connectable with one another to form a first portion of a completed puzzle, and each puzzle tile of the first plurality of puzzle tiles includes a respective portion of a picture. The respective portions of the picture form a first picture when the plurality of puzzle tiles are connected to form the first portion of the completed puzzle, the first picture depicting an individual performing a first position of an athletic movement. The method also includes observing a second position of the athletic movement by assembling a second portion of the jigsaw puzzle (e.g., 24 or 122), the second portion of the jigsaw puzzle including a second plurality of puzzle tiles. Puzzle tiles included in the second plurality of puzzle tiles are connectable with one another to form a second portion of the completed puzzle, and each puzzle tile of the second plurality of puzzle tiles includes a respective portion of a picture. The respective portions of the picture form a second picture when the plurality of puzzle tiles are connected to form the second portion of the completed puzzle, the second picture depicting an individual performing a second position of an athletic movement. The method further includes observing a sequential transition from the first position to the second position by assembling the first portion of the jigsaw puzzle to the second portion of the jigsaw puzzle. In a further aspect, the first portion of the jigsaw puzzle is assembled before assembling the second portion of the jigsaw puzzle to the first portion of the jigsaw puzzle.

From the foregoing, it will be seen that this invention is one well adapted to attain all the ends and objects hereinabove set forth together with other advantages which are obvious and which are inherent to the structure.

It will be understood that certain features and subcombinations are of utility and may be employed without reference to other features and subcombinations. This is contemplated by and is within the scope of the claims.

Since many possible embodiments may be made of the invention without departing from the scope thereof, it is to be understood that all matter herein set forth or shown in the accompanying drawings is to be interpreted as illustrative and not in a limiting sense.

1. A system for teaching athletic-movement technique, the system comprising:
a jigsaw puzzle having a plurality of puzzle tiles that are connectable with one another to form a completed puzzle,
each puzzle tile of the plurality of puzzle tiles including a respective portion of a picture, and
the respective portions of the picture forming the picture when the plurality of puzzle tiles are connected to form the completed puzzle, wherein the picture depicts an individual performing an athletic movement that includes an execution of a series of sequential movements, and wherein the picture depicts a first position of an athletic movement and a second position of the athletic movement, the second position occurring sequentially after the first position when the athletic movement is executed.

2. The system of claim 1, wherein the athletic movement includes running, weightlifting, or gymnastics.

3. The system of claim 1, wherein the athletic movement includes a clean-and-jerk weightlifting movement, wherein the first position includes a first hip position, a first back angle, and a first shoulder position, wherein the second position includes a second hip position, a second back angle, and a second shoulder position, and wherein at least one of the second hip position, the second back angle, and the second shoulder position is different from the first hip position, the first back angle, and the first shoulder position.

4. The system of claim 1, wherein the athletic movement includes a snatch weightlifting movement, wherein the first position includes a first hip position, a first back angle, and a first shoulder position, wherein the second position includes a second hip position, a second back angle, and a second shoulder position, and wherein at least one of the second hip position, the second back angle, and the second shoulder position is different from the first hip position, the first back angle, and the first shoulder position.

5. The system of claim 1,
wherein the plurality of puzzle tiles includes a first set of puzzle tiles that are connectable to depict the first position of the athletic movement,
wherein the plurality of puzzle tiles includes a second set of puzzle tiles that are connectable to depict the second position of the athletic movement,
wherein the first set of puzzle tiles includes a first interlocking-edge configuration that is repeated in each puzzle tile included in the first set of puzzle tiles, and
wherein the second set of puzzle tiles includes a second interlocking-edge configuration that is repeated in each puzzle tile included in the second set of puzzle tiles, the first interlocking-edge configuration being different from the second interlocking-edge configuration.

6. The system of claim 5, wherein the first interlocking-edge configuration includes a first edge path that is generally aligned with a first human-joint alignment in the first position of the athletic movement, and wherein the second interlocking-edge configuration includes a second edge path that is generally aligned with a second human-joint alignment in the second position of the athletic movement.

7. The system of claim 1, wherein the picture depicts at least five positions of the athletic movement.

8. The system of claim 1, wherein the picture depicts a first individual performing the athletic movement and a second individual performing the athletic movement.

9. The system of claim 1 further comprising, a computer application that renders the plurality of puzzle tiles on a display of an electronic device, wherein the puzzle tiles are movable using an input device to assemble the completed puzzle.

10. The system of claim 9, wherein the input device includes a touch-sensitive surface.

11. The system of claim 10, wherein the input device includes a mouse.

12. A method of learning technique of an athletic movement, the method comprising:
observing a first position of the athletic movement by assembling a first portion of a jigsaw puzzle, the first portion of the jigsaw puzzle including a first plurality of puzzle tiles,
wherein puzzle tiles included in the first plurality of puzzle tiles are connectable with one another to form a first portion of a completed puzzle,
wherein each puzzle tile of the first plurality of puzzle tiles includes a respective portion of a picture, and
wherein the respective portions of the picture form a first picture when the plurality of puzzle tiles are connected to form the first portion of the completed puzzle, the first picture depicting an individual performing a first position of an athletic movement; and
observing a second position of the athletic movement by assembling a second portion of the jigsaw puzzle, the second portion of the jigsaw puzzle including a second plurality of puzzle tiles,
wherein puzzle tiles included in the second plurality of puzzle tiles are connectable with one another to form a second portion of the completed puzzle,
wherein each puzzle tile of the second plurality of puzzle tiles includes a respective portion of a picture, and
wherein the respective portions of the picture form a second picture when the plurality of puzzle tiles are connected to form the second portion of the completed puzzle, the second picture depicting an individual performing a second position of an athletic movement; and
observing a sequential transition from the first position to the second position by assembling the first portion of the jigsaw puzzle to the second portion of the jigsaw puzzle.

13. The method of claim 12 further comprising, assembling the first portion of the jigsaw puzzle before assembling the second portion of the jigsaw puzzle to the first portion of the jigsaw puzzle.

14. The method of claim 12,
wherein assembling the first portion of the jigsaw puzzle includes assembling the first plurality of puzzle tiles having a first interlocking-edge configuration that is repeated in each puzzle tile included in the first plurality of puzzle tiles, the first interlocking-edge configuration including a first edge path that is generally aligned with a first human-joint alignment of the first position of the athletic movement, and
wherein assembling the second portion of the jigsaw puzzle includes assembling the second plurality of puzzle tiles having a second interlocking-edge configuration that is repeated in each puzzle tile included in the second plurality of puzzle tiles, the second interlocking-edge configuration including a second edge path that is generally aligned with a second human-joint alignment of the second position of the athletic movement.

15. The method of claim 12 wherein the first and second plurality of puzzle tiles are digitally represented on a display device of a computer and wherein assembling the first portion and the second portion includes using a touchscreen to manipulate the puzzle tiles.
